(19) United States
(12) Patent Application Publication
(10) Pub. No.: US 2001/0037789 A1
(43) Pub. Date: Nov. 8, 2001

(54) Method of manufacturing a monobloc

(76) Inventor: Patrick Walker, Banbury (GB)

Correspondence Address: Woodcock Washburn Kurtz, Mackiewicz & Norris LLP, One Liberty Place - 46th Floor, Philadelphia, PA, 19103, US

(21) Appl. No.: 09/804,748

(22) Filed: Mar. 13, 2001

(30) Foreign Application Priority Data
Mar. 15, 2000 (GB) 0006274.5

(51) Int. Cl. F02F 1/00; B23P 11/00; F02F 7/00

(52) U.S. Cl. 123/195 R; 123/193.2; 29/888.061

(57) ABSTRACT

The present invention relates to a method of manufacturing a monobloc 10.

The method comprises the steps of providing a monobloc 10 having a cylinder 16, 18, the cylinder 16, 18 having an open end 12 and a blind end 14 remote from the open end, and providing a cylindrical liner 28 for the cylinder.

The method also comprises machining, such as boring, part of an inside surface 32 of the cylindrical liner to provide an undercut 38. Then, the cylindrical liner is fitted in the cylinder.

Once the cylindrical liner 28 is in situ in the cylinder 16, 18 substantially the remainder of the inside surface 32 of the cylindrical liner may be honed.

The present invention relates to a method of manufacturing a monobloc and improvements in monobloc design. A monobloc according to the invention is primarily, but not exclusively, intended for use as part of an internal combustion engine, such as for a high performance vehicle (for example, a motor racing vehicle) or a high performance craft (for example, a jet ski).

In a conventional internal combustion (I.C.) engine, a cylinder block bored with cylinders to receive the pistons is fastened to a removable cylinder head so that, when in place, the cylinder head provides a gas-tight seal for the cylinders. In a monobloc, the cylinder block and cylinder head are an integral casting.

It is known to hone an inside surface of a cylinder liner whilst in situ in a cylinder block of a conventional I.C. engine. Honing produces a rough surface which holds oil and improves the performance of the engine. However, in the case of a monobloc, honing of the inside surface of a cylinder liner in situ in the engine is difficult as, due to the monobloc being an integral casting, the cylinder liner can only be accessed from an open end at one end thereof. Consequently, operation of a honing machine on the inside surface of the cylinder liner of a monobloc when the liner is in situ in the respective cylinder is somewhat difficult, especially towards a blind end of the cylinder remote from the open end.

It is an aim of the present invention to provide an improved and/or easier method of manufacturing a monobloc.

In a conventional engine, coolant is passed around each cylinder in series. The progressive heating of the coolant reduces its cooling effect. With that in mind it is another aim of the invention to provide an improved cooling arrangement for a monobloc.

A further aim of the invention is to provide a monobloc with symmetry so that it can be used in more than one engine configuration.

Another object of the invention is general improvement in the method of manufacture of monoblocs and/or in the design and structure of a monobloc.

According to a first aspect of the invention there is provided a method of manufacturing a monobloc, comprising the steps of:

providing a monobloc having a cylinder, the cylinder having an open end and a blind end remote from the open end,

providing a cylindrical liner for the cylinder,

machining, such as boring, part of an inside surface of the cylindrical liner to provide an undercut, and then

fitting the cylindrical liner in the cylinder.

In that way, an undercut is present when the cylindrical liner is in situ in the cylinder. It will be appreciated that it is easier to operate on the inside surface of the cylindrical liner when not in situ, for example by accessing the inside surface from either of the ends as opposed to only one end when it is in situ against the blind end of the cylinder.

Preferably the method is characterised by boring the undercut at an end of the cylindrical liner adapted to lie adjacent the blind end. That is advantageous in that the end of the cylindrical liner adapted to lie adjacent the blind end which is most inaccessible when the cylindrical liner is in situ need not be bored in situ.

Preferably the method is characterised by boring the undercut in the form of an annular recess or annular groove. The uniform shape provided by an annular recessed or annular grooved undercut means that it is easier to know the extent of the undercut when the cylindrical liner is in situ in a monobloc cylinder.

The undercut allows the correct honing cross-hatching angle to be maintained throughout the travel of piston rings.

Preferably, the method is characterised by boring the undercut of the cylindrical liner to substantially the finished bore size of the cylindrical liner. It will be appreciated that the finished bore size of the cylindrical liner maintains a substantially continuous profile with the cylinder, thereby giving performance advantages to the monobloc.

The method may be characterised by boring for a depth of say less than 0.5 mm, and preferably to 0.25 mm. The method may also/alternatively be characterised by honing the cylindrical liner for a distance axially along the cylindrical liner between, say 4 and 6 mm (and preferably 5 mm).

The method is preferably characterised by honing substantially the remainder of the inside surface of the cylindrical liner when the cylindrical liner is in situ in the cylinder, and preferably only the part between the undercut and the end of the liner adapted to lie adjacent the opening of the cylinder.

Preferably the method is characterised by honing the remainder of the inside surface in a plurality of passes which give increasing optimum surface characteristics (roughness) to the inside surface of the cylindrical liner.

The method may be characterised by providing one or more further cylinders similar to the cylinder of the first aspect of the invention, and one or more further cylindrical liners, boring the or each further cylindrical liners in a similar manner to the first aspect of the invention. Preferably, in one embodiment, the method comprises providing two cylinders and providing two respective cylindrical liners.

The blind end of the cylinder forms part of the combustion chamber.

It is difficult to accurately form the combustion chamber profile of the cylinder.

In that respect the method may be characterised by spark eroding the profile of the blind end of a cylinder. In that manner a profile can be very accurately formed.

According to a second aspect of the invention there is provided a method of manufacturing a cylinder of a monobloc, the method being characterised by introducing spark erosion apparatus into the cylinder towards a blind end thereof, and spark eroding the profile of the blind end of the cylinder.

In that way, the profile of the blind end of the cylinder can be accurately achieved.

According to a third aspect of the invention there is provided a cylindrical liner for a cylinder of a monobloc, the cylindrical liner having an inside surface for receiving a piston, the inside surface comprising an undercut or region of additional machining only at one end thereof which is adapted to locate adjacent a blind end of the cylinder. In that way, a section which would be difficult to bore in situ, and only that section, can be bored prior to locating the cylindrical liner in the cylinder. The remainder of the cylindrical liner which is easier to access can be honed when the cylindrical liner is in situ.

According to a fourth aspect of the invention there is provided a monobloc for an I.C. engine, comprising a cylindrical liner according to the third aspect of the invention. Preferably the cylindrical liner has an outer flange. Most preferably, the flange is locatable in installation at an open end of the cylinder.

According to a fifth aspect of the invention there is provided a monobloc assembly for an internal combustion engine, the monobloc assembly comprising one or more cylinders and one or more respective pistons. Each piston is arranged for reciprocating movement in its respective cylinder, characterised in that the monobloc has a cylinder bore/piston stroke ratio of greater or equal to 1:25; 1.

The cylinder bore may be of a diameter between 88 mm and 108 mm, and is preferably 98 mm in diameter. The piston stroke may be of a distance 56 mm to 76 mm and is preferably 66 mm. Such dimensions are adapted to allow access of a machining tool to the blind end of the cylinder when the cylindrical liner is in situ in the cylinder.

When the method comprises providing one or more further cylinders preferably the cylinder and the or each further cylinder has a fluid coolant passage around it, characterised in that the passages are adapted to allow independent flow of fluid coolant around the cylinders and the or each further cylinder.

According to a sixth aspect of the invention there is provided a monobloc having a plurality of cylinders, each cylinder having a fluid coolant passage around it, characterised in that the passages are adapted to allow independent flow of fluid coolant around the cylinders.

Preferably, each fluid coolant passage has its own inlet to, and its own exit from, the monobloc to allow parallel independent flow of coolant through the monobloc and around the cylinders.

In a preferred embodiment of the invention, the longitudinal axes of the plurality of cylinders are substantially parallel and, most preferably, the plurality of cylinders are side by side.

According to a seventh aspect of the invention there is provided a monobloc casting for an I.C. engine, the monobloc casting having one or more cylinders, wherein the monobloc casting has at least one degree of reflective symmetry.

In one embodiment of the invention the reflective symmetry is in relation to a plane (PA) which passes through the longitudinal axes of the one or more cylinders. This would involve producing a monobloc having inlet and exhaust ports of substantially identical size.

Alternatively or additionally the reflective symmetry is in relation to a plane (PB) perpendicular to a plane (PA) through the longitudinal axes of the one or more cylinders.

According to an eighth aspect of the invention there is provided an I.C. engine having a monobloc in accordance with any of the preceding aspects or the consistory clauses relating thereto. According to a ninth aspect of the invention there is provided a vehicle having a monobloc in accordance with any of the first to the seventh aspects or the consistory clauses relating thereto.

A monobloc and a method of manufacturing a monobloc in accordance with the invention will now be described with reference to the accompanying drawings in which:

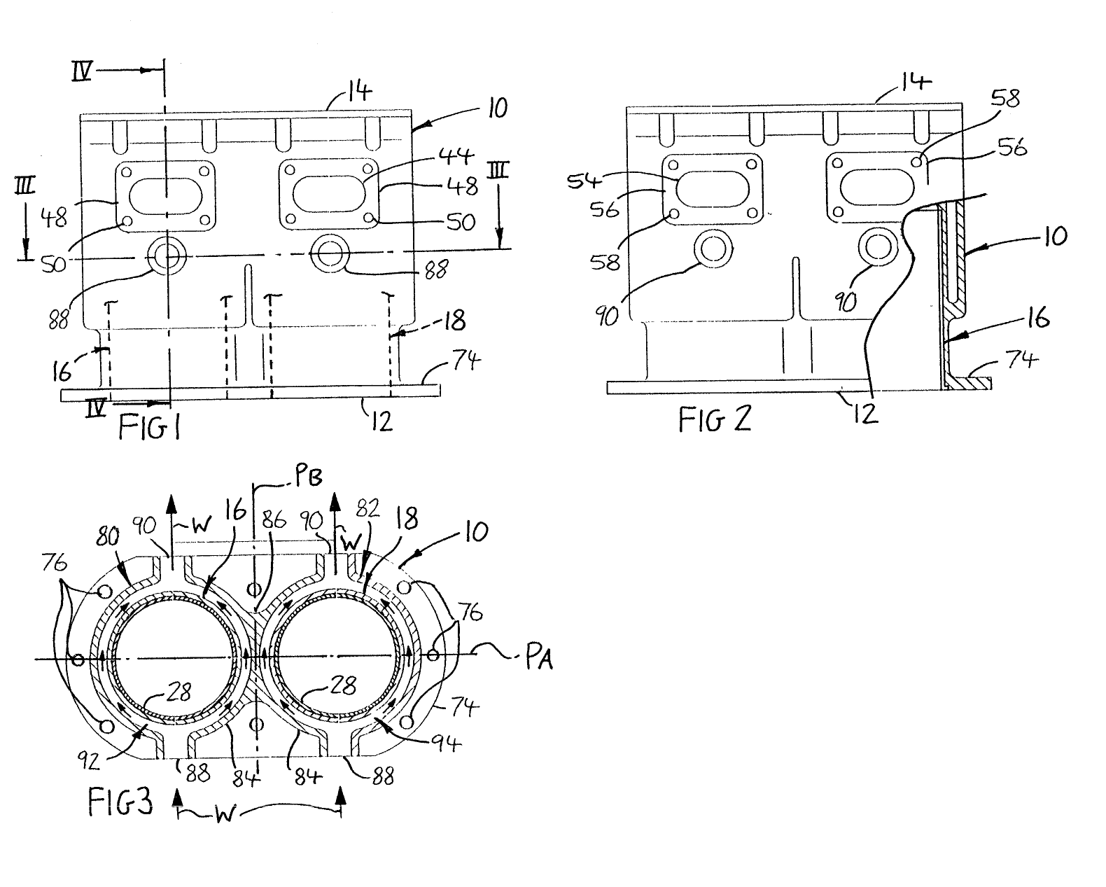

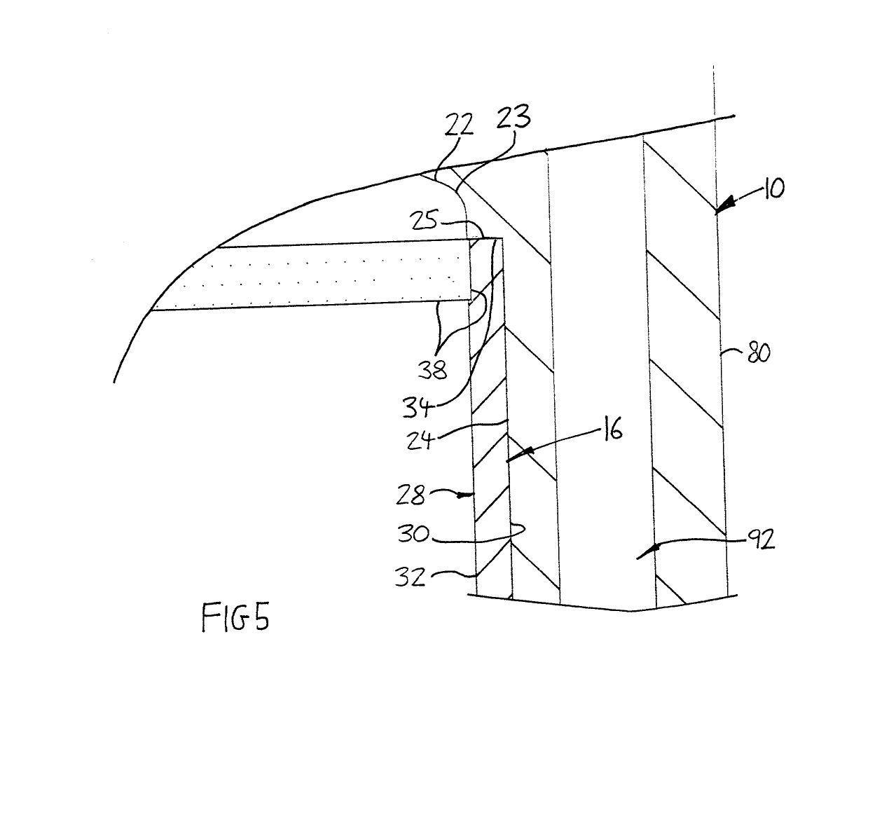

FIG. 1 is an elevation of a monobloc manufactured using a method in accordance with the invention taken along line II in FIG. 4,

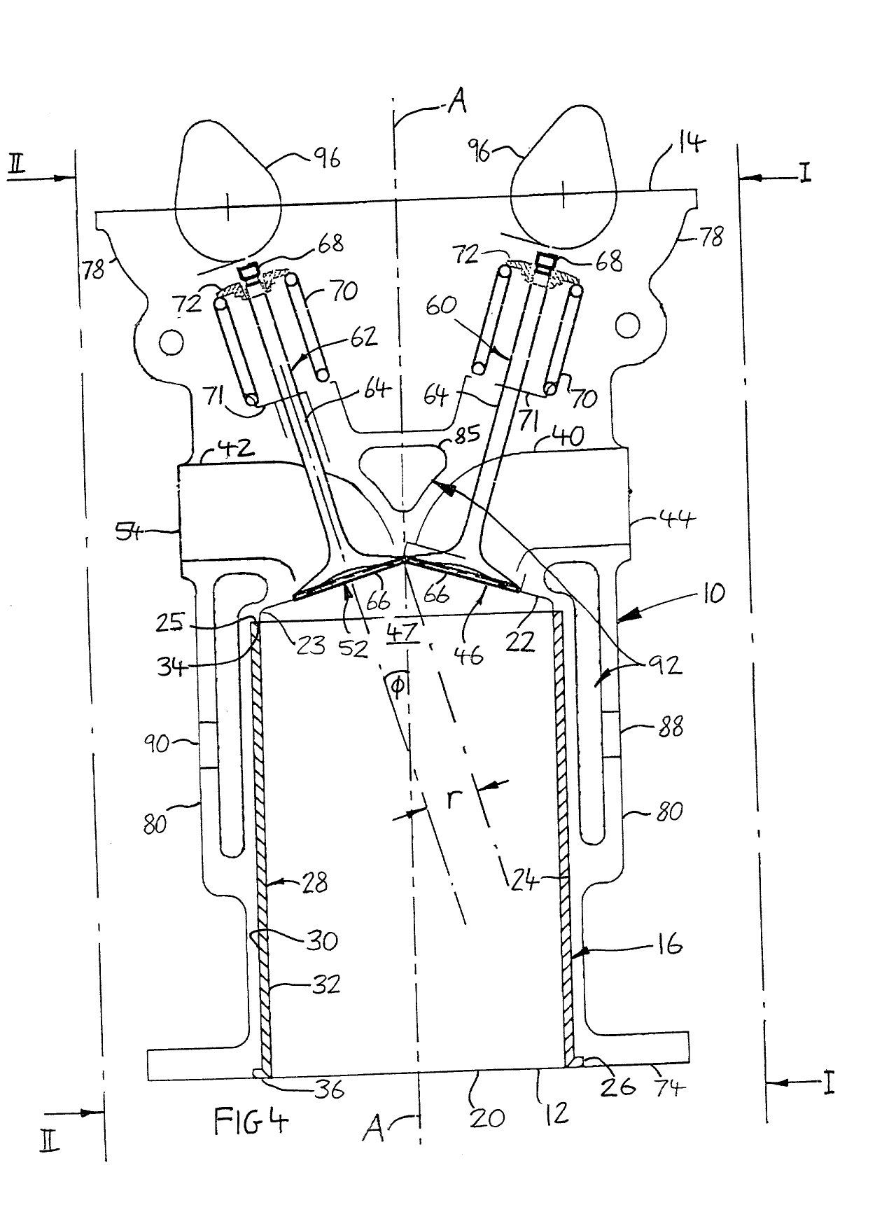

FIG. 2 is another elevation of an opposite side of the monobloc taken along line II-II in FIG. 4,

FIG. 3 is a cross sectional plan view of the monobloc taken along line III-III in FIG. 1,

FIG. 4 is a cross section of the monobloc taken along the line IV-IV in FIG. 1,

FIG. 5 is an exploded view of part of a first cylinder of the monobloc, and

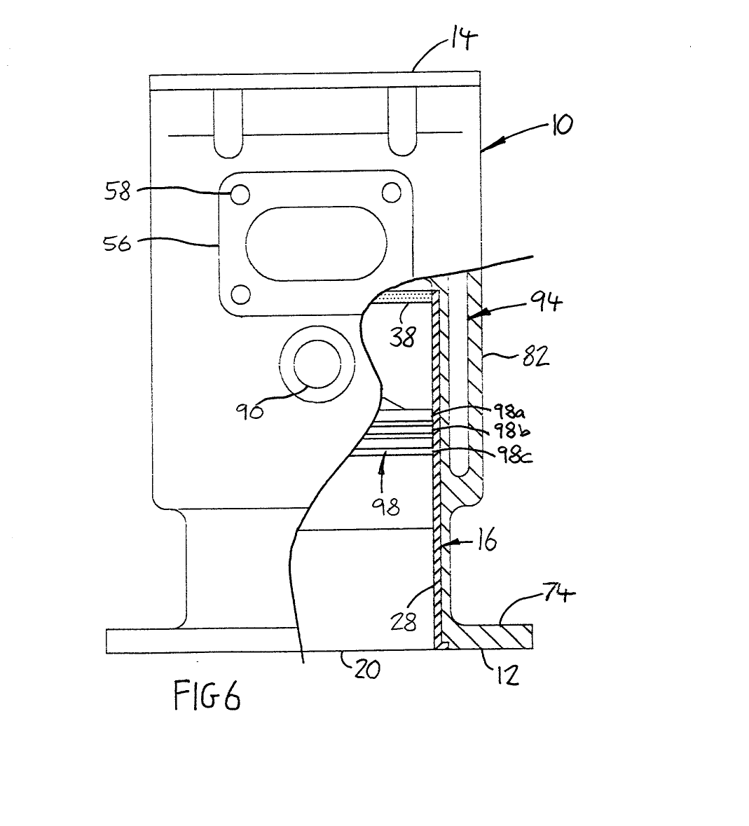

FIG. 6 is a side view of another monobloc manufactured using a method in accordance with the invention, a cut away section showing how a piston operates in the first cylinder.

Referring to FIGS. 1 to 4, a monobloc 10 comprises a first end 12 and a second end 14.

The monobloc 10 comprises a first cylinder 16 and a second cylinder 18, both of which extend from the first end 12 of the monobloc towards the second end 14 thereof.

The first and second cylinders 16, 18 are substantially similar and for that reason only the first cylinder 16 will be described in detail.

The first cylinder 16 comprises an open end 20 and a blind end 22. The blind end 22 is of generally conical form. A rounded part 23 joins the blind end 22 to a cylindrical wall 24 of the first cylinder 16. A mating shoulder 25 is defined between cylindrical wall 24 and the blind end 22.

The first and second cylinders 16, 18 each have longitudinal axes A and a plane PA passes through axes A of the cylinders 16, 18.

The first cylinder 16 also comprises a recess 26 for a flange 36 forming part of a liner 28.

The liner 28 is of cylindrical form and has an outside surface 30 and an inside surface 32. It also has a mating end 34 and at an end remote from the mating end it has an outer annular flange 36. The liner 28 has, on its inside surface 32 an undercut 38, which can best be seen in FIG. 5. Accordingly, the undercut 38 is a region on the liner 28 which is recessed, or has a larger internal diameter, compared to most of the remaining inside surface 32 (as shown in figures), or at least a part of the inside surface 32 adjacent to the undercut. The inside surface 32 is a diameter of, say 97.75 mm and the undercut 38 is a diameter of, say 98 mm.

Each of the first and second cylinders 16, 18 of the monobloc 10 also comprise an inlet port 40 and an exhaust port 42. The inlet and exhaust ports 40, 42 are to allow fuel/air mixture to pass into the first and second cylinders 16,18 and combustion gases to pass out of the first and second cylinders 16, 18. The inlet and exhaust ports 40, 42 may be substantially similar and therefore only the inlet and exhaust ports 40, 42 in relation to the first cylinder 16 will be described.

The inlet port 40 comprises an inlet port entry 44 and an inlet port opening 46 in the blind end 22 which leads into a combustion region 47 of the first cylinder 16. The inlet port entry 44 may be oval as shown in FIG. 1. At the inlet port entry 44 there is a fastening section 48 and fastening apertures 50 to receive fasteners such as threaded bolts (not shown) so as to be able to fasten an inlet system (not shown) thereto.

The exhaust port 42 comprises an exhaust port opening 52 in the blind end 22 and an exhaust port exit 54. The exhaust port exit 54 may be oval as shown in FIG. 2. At the exhaust port exit 54 it comprises a further fastening section 56 which has further fastening apertures 58 to allow fastening of an exhaust (not shown) thereto.

The monobloc 10 comprises a first valve 60 (the inlet valve) and a second valve 62 (the exhaust valve). The valves 60, 62 may be substantially the same and so only the first valve 60 will be described in detail. The first inlet valve 60 is typically bigger than the second exhaust valve 62.

The first valve 60 comprises a stem 64 which has at one end a head 66 adapted to close the inlet port opening 46. The head 66 lies flush with the blind end 22 when the inlet port opening 46 is closed. At the other end of the stem 64 there is a tip 68 adapted to abut against a cam. The head 66 has a radius r. Biasing means such as a spring 70 arranged on a seat 71 of the monobloc 10 are adapted to maintain the tip 68 in contact with its respective cam. An oil seal 72 seals around the stem 64. The angle between the first/second valve 60, 62 and the longitudinal axis A is indicated at φ. φmust be small to enable machining of the inlet port 40 and the exhaust port 42.

The monobloc 10 further comprises a mounting base 74 which has a series of apertures 76, the mounting base 74 is at the first end 12 of the monobloc and is for mounting the monobloc onto a crankcase (not shown) of a vehicle or the like. At the second end 14 of the monobloc 10 shoulders 78 are provided to provide a seat for cams.

The monobloc 10 also comprises a first jacket 80 and a second jacket 82. The first jacket 80 is arranged around the first cylinder 16 and the second jacket 82 is similarly arranged around the second cylinder 18.

The jackets 80, 82 are substantially the same and so only the first jacket 80 will be described in detail.

The first jacket 80 comprises a cylindrical wall 84 and a heart-shaped portion 85. The cylindrical wall 84 is concentric to the first cylinder 16. The heart-shaped portion 85 passes between the first and second valves 60, 62 and around the blind end 22 of the first cylinder 16.

A common wall 86 forms part of the cylindrical wall 84 of the first jacket 80 and part of the cylindrical wall 84 of the second jacket 82. A plane perpendicular to the plane PA and through the common wall 86 is shown at PB.

Each jacket 80, 82 has a jacket inlet 88 and a jacket outlet 90. It will be noted that the jacket inlet 88 and the jacket outlet 90 are diametrically opposed. It will also be noted that the jacket inlet 88 and the jacket outlet 90 are perpendicular to the plane PA through the longitudinal axes A of the cylinders 16, 18. Each of the first jacket 80 and the second jacket 82 define a first channel 92 and a second channel 94 respectively.

Now, considering the method of manufacture, assembly and operation of the monobloc, the blind end 22 of the cylinders 16, 18 is preferably formed by introducing a spark eroding apparatus (not shown) into the cylinder 16,18. The spark eroding apparatus has a desired conical cylindrical profile and operation of the spark eroding apparatus gradually turns the blind end 22 to a corresponding shape.

Preferably, the liner undercut 38 is bored on its inside surface 32 prior to insertion into the first cylinder 16. Referring to FIG. 5, the boring machine (not shown) is introduced into the liner 28 and bores, at one end of its inside surface 32, the undercut 38. The undercut 38 extends, say, 5 mm and has a diameter of, say, 98 mm.

After the undercut 38 is formed, the liner 28 is inserted, undercut 28 first, into the first cylinder 16. The liner 28 is introduced until its mating end 34 is in abutment with the mating shoulder 25 of the first cylinder 16. It will be noted that the undercut 38 has a diameter substantially similar to that of finished bore size.

Honing of the inside surface 32 of the liner 28 can be effected after the liner 28 is in situ in the cylinder 16. More specifically, a honing machine (not shown) is introduced into the liner 28 and the liner 28 is preferably honed in the vicinity from the undercut 38 to the end of the liner 28 remote therefrom. It is honed in a plurality of passes such as two or three. A first pass gives an optimum degree of roughness, the second pass gives a lesser degree of roughness. The honing operation is undertaken at an angle of cross hatching such as 30° from a plane perpendicular to place A. The honing machine only works to the finished bore size i.e. 98 mm so there will be little or no interference with the undercut 38. The honing machine may be automatically controlled.

Referring to FIGS. 1 to 4, to assemble the monobloc 10, fasteners (not shown) are passed through the apertures 76 in the mounting base 74 and into part of an engine block (not shown). The fastening section is fastened at the fastening apertures 50 to the inlet supply (not shown) and the further fastening section 56 is fastened at the further fastening apertures 58 to the exhaust (not shown). In that way fuel/air mixture and combustion gases can move from the inlet supply to the inlet port and from the exhaust port exit to the exhaust respectively.

In use, cams 96 of a camshaft (not shown) each engage with the tips 68 of, respectively, the first and second valve 60, 62.

FIG. 6 shows a monobloc 10 having a single cylinder 16. A piston 98 is introduced into the liner 28 of the first cylinder 16 and is free to move reciprocate inside thereof. The piston 98 has a top ring 98a, a second ring 98b and an oil control ring 98c.

The monobloc 10 allows operation of the known induction—compression—power exhaust strokes of operation of an I.C. engine.

As the engine operates coolant W such as water or other fluid, can be introduced into the jacket inlets 88 (shown in FIG. 1).

Referring to FIG. 3, coolant W flows through the first channel 92 and the second channel 94 completely independently of each other.

It can be seen from FIG. 3 that the monobloc 10 has at least two axes of reflective symmetry. Firstly, plan PA and, secondly, plane PB. That means that the orientation of the monobloc 10 in the engine compartment can be changed with greater ease, and that the monobloc 10 can be used on either side of a horizontally opposed, V or in-line configuration or arrangement.

It will be appreciated that a drill can be used to provide the undercut (instead of a boring machine for example). However, since accurate, and indeed preferably great accuracy, is required, boring is preferable.

1. A method of manufacturing a monobloc, comprising the steps of:
providing a monobloc having a cylinder, the cylinder having an open end and a blind end remote from the open end,
providing a cylindrical liner for the cylinder,
machining, such as boring, part of an inside surface of the cylindrical liner to provide an undercut, and then
fitting the cylindrical liner in the cylinder.

2. A method according to claim 1, wherein the method comprises boring the undercut at an end of the cylindrical liner adapted to lie adjacent the blind end.

3. A method according to claim 1, wherein the method comprises boring the undercut in the form of an annular recess or annular groove.

4. A method according to claim 1, wherein the method comprises boring the undercut of the cylindrical liner to substantially the finished bore size of the cylindrical liner.

5. A method according to claim 1, wherein the method comprises boring for a depth of say less than 0.5 mm.

6. A method according to claim 1, wherein the method comprises boring to a depth of 0.25 mm.

7. A method according to claim 1, wherein the method comprises honing the cylindrical liner for a distance axially along the cylindrical liner of between, say 4 and 6 mm.

8. A method according to claim 1, wherein the method comprises honing only the part between the undercut and the end of the liner adapted to lie adjacent the opening of the cylinder.

9. A method according to claim 1, wherein the method comprises honing substantially the remainder of the inside surface of the cylindrical liner when the cylindrical liner is in situ in the cylinder.

10. A method according to claim 9, wherein the method comprises honing the remainder of the inside surface in a plurality of passes which give increasing optimum surface characteristics to the inside surface of the cylindrical liner.

11. A method according to claim 1, wherein the method comprises providing one or more further cylinders, and one or more further cylindrical liners, boring the or each further cylindrical liners and fitting the or each further cylinder in the or each further cylindrical liners.

12. A method according to claim 11, wherein the method comprises providing the cylinder and the or each further cylinder with fluid coolant passages around them, characterised in that the passages are adapted to allow independent flow of fluid coolant around the cylinders and the or each further cylinder.

13. A method according to claim 11, the method comprises providing two cylinders and providing two respective cylindrical liners.

14. A method of manufacturing a cylinder of a monobloc, the method being characterised by introducing spark erosion apparatus into the cylinder towards a blind end thereof, and spark eroding the profile of the blind end of the cylinder.

15. A cylindrical liner for a cylinder of a monobloc, the cylindrical liner having an inside surface for receiving a piston, the inside surface comprising an undercut or region of additional machining only at one end thereof, which is adapted to locate adjacent a blind end of the cylinder.

16. A monobloc for an I.C. engine, comprising a cylindrical liner in accordance with claim 15.

17. A monobloc assembly for an internal combustion engine, the monobloc assembly comprising one or more cylinders and one or more respective pistons, each piston being arranged for reciprocating movement in its respective cylinder, characterised in that the monobloc has a cylinder bore/piston stroke ratio of at least 1.25; 1.

18. A monobloc having a plurality of cylinders, each cylinder having a fluid coolant passage around it, characterised in that the passages are adapted to allow independent flow of fluid coolant around the cylinders.

19. A monobloc according to claim 18, wherein each fluid coolant passage has its own inlet to, and its own exit from, the monobloc to allow parallel independent flow of coolant through the monobloc and around the cylinders.

20. A monobloc according to claim 18, each cylinder having a longitudinal axis, wherein the longitudinal axes of the plurality of cylinders are substantially parallel.

21. A monobloc according to claim 18, wherein the plurality of cylinders are side by side.

22. A monobloc casting for an I.C. engine, the monobloc casting having one or more cylinders, wherein the monobloc casting has at least one degree of reflective symmetry.

23. A monobloc casting according to claim 22, wherein the reflective symmetry is in relation to a plane (PA) which passes through the longitudinal axes of the one or more cylinders.

24. A monobloc casting according to claim 22, wherein the reflective symmetry is in relation to a plane (PB) perpendicular to a plane (PA) through the longitudinal axes of the one or more cylinders.

25. An I.C. engine having a monobloc, made in accordance with the method of claim 1.

26. A vehicle having a monobloc, made in accordance with the method of claim 1.
